(19) United States
(12) Patent Application Publication
(10) Pub. No.: US 2017/0359742 A1
(43) Pub. Date: Dec. 14, 2017

(54) MONITORING APPARATUS, WIRELESS COMMUNICATION APPARATUS, COMMUNICATION SYSTEM, LINE USE RATE CALCULATION METHOD, DATA TRANSMISSION METHOD, MONITORING METHOD, AND COMPUTER-READABLE MEDIUM

(71) Applicant: NEC Corporation, Tokyo (JP)

(72) Inventor: Koji KAWADA, Tokyo (JP)

(73) Assignee: NEC Corporation, Tokyo (JP)

(21) Appl. No.: 15/541,397

(22) PCT Filed: Dec. 9, 2015
(86) PCT No.: PCT/JP2015/006138

§ 371 Date: Jul. 3, 2017

(30) Foreign Application Priority Data
Jan. 5, 2015 (JP) 2015-000181

(51) Int. Cl. H04W 24/08; H04W 24/10; H04L 12/26

(52) U.S. Cl. CPC H04W 24/08; H04L 43/0894; H04W 24/10

(57) ABSTRACT

A monitoring apparatus includes: a data collection unit that collects from a wireless communication apparatus log information including information indicating change in a modulation scheme within a previously fixed first time period; an analysis unit that fixes the wireless communication apparatus as a monitored apparatus, in a case where the number of changes in the modulation scheme exceeds a first threshold value in the first time period; a data collection unit that collects from the wireless communication apparatus information on a modulation scheme applied when wireless communication is performed for each second time period shorter than the first time period, and information on a data amount transmitted and received by applying the modulation scheme in the second time period; and a line use rate calculation unit that calculates a line use rate of a wireless line in a wireless section using the information collected in the data collection unit.

### TECHNICAL FIELD

The present invention relates to calculation of a line use rate and, for example, to a monitoring apparatus, a wireless communication apparatus, a communication system, a line use rate calculation method, a data transmission method, a monitoring method, and a program that calculate a line use rate of a wireless section.

### BACKGROUND ART

In recent years, there have been an increasing number of communication carriers who construct a communication network between apparatuses using a wireless communication line. For example, the wireless communication line is used between base stations in a mobile phone network. A system can be constructed inexpensively in a short time period regardless of terrains between the apparatuses by using the wireless communication line between the apparatuses, such as the base stations.

In a case of using the wireless communication line between the apparatuses, it is necessary to grasp fluctuations etc. in a traffic amount between the apparatuses, and to apply an appropriate line capacity according to the traffic amount. For grasping the fluctuations in the traffic amount between the apparatuses, calculation methods of a use rate of the wireless communication line are disclosed in Patent Literatures 1 and 2.

Patent Literature 1 describes calculating a use rate of a wireless channel using the number of used time slots. In addition, Patent Literature 2 describes a method of measuring a wireless use rate for each terminal in a wireless communication system using a CDMA (Code Division Multiple Access) scheme.

### CITATION LIST

### Patent Literature

### Patent Literature 1

Japanese Unexamined Patent Application Publication No. 2007-074239

### Patent Literature 2

Japanese Unexamined Patent Application Publication No. 2013-021503

### SUMMARY OF INVENTION

### Technical Problem

In a case of applying the appropriate line capacity according to the traffic amount, a monitoring apparatus that monitors a communication system desirably measures traffic of all wireless communication lines in real time. However, the monitoring apparatus needs to collect traffic information from a number of apparatuses, in a case of measuring the traffic of all the wireless communication lines in real time. In a case where the monitoring apparatus collects the traffic information from a number of apparatuses, there arises a problem that the traffic information transmitted and received in the communication system increases, and thus the communication system is congested.

An object of the present invention is to provide a monitoring apparatus, a wireless communication apparatus, a communication system, a line use rate calculation method, a data transmission method, a monitoring method, and a program that can efficiently collect traffic information of a wireless communication line in a communication system.

### Solution to Problem

A monitoring apparatus according to a first aspect of the present invention includes: a first data collection unit that collects log information including information indicating change in a modulation scheme within a previously fixed first time period, from a wireless communication apparatus that changes the modulation scheme in conformity with a change in environment of a wireless section; an analysis unit that fixes as a monitored apparatus the wireless communication apparatus that transmitted the log information, in a case where the number of changes in the modulation scheme exceeds a first threshold value in the first time period; a second data collection unit that collects information on a modulation scheme applied when wireless communication is performed for each second time period shorter than the first time period, and information on a data amount transmitted and received by applying the modulation scheme in the second time period, from the wireless communication apparatus specified as the monitored apparatus; and a line use rate calculation unit that calculates a line use rate of a wireless line in the wireless section using the information collected in the second data collection unit.

A wireless communication apparatus according to a second aspect of the present invention includes: a log information generation unit that generates log information that indicates information indicating change in a modulation scheme and information on a data amount transmitted and received by applying the modulation scheme, when the modulation scheme was changed in conformity with a change in environment of a wireless section; and a communication unit that transmits to a monitoring apparatus the log information generated within a previously fixed first time period.

A communication system according to a third aspect of the present invention includes: a wireless communication apparatus that generates log information indicating information on a data amount transmitted and received by applying a modulation scheme before changed, when the modulation scheme was changed in conformity with a change in environment of a wireless section; and a monitoring apparatus that collects the log information generated in the wireless communication apparatus within a previously fixed first time period, fixes as a monitored apparatus the wireless communication apparatus that transmitted the log information in a case where the number of changes in the modulation scheme exceeds a first threshold value, collects information on a modulation scheme applied when wireless communication is performed for each second time period shorter than the first time period, and information on a data amount transmitted and received by applying the modulation scheme in the second time period, from the wireless communication apparatus specified as the monitored apparatus, and calculates a line use rate of a wireless line in the wireless section.

A line use rate calculation method according to a fourth aspect of the present invention is for: collecting log information including information indicating change in a modulation scheme within a previously fixed first time period, from a wireless communication apparatus that changes the modulation scheme in conformity with a change in environment of a wireless section; fixing as a monitored apparatus the wireless communication apparatus that transmitted the log information, in a case where the number of changes in the modulation scheme exceeds a first threshold value in the first time period; collecting information on a modulation scheme applied when wireless communication is performed for each second time period shorter than the first time period, and information on a data amount transmitted and received by applying the modulation scheme in the second time period, from the wireless communication apparatus specified as the monitored apparatus; and calculating a line use rate of a wireless line in the wireless section using the information collected for each the second time period.

A data transmission method according to a fifth aspect of the present invention is for: generating log information that indicates information indicating change in a modulation scheme and information on a data amount transmitted and received by applying the modulation scheme, when the modulation scheme was changed in conformity with a change in environment of a wireless section; and transmitting to a monitoring apparatus the log information generated within a previously fixed first time period.

A monitoring method according to a sixth aspect of the present invention is for: generating log information indicating information on a data amount transmitted and received by applying a modulation scheme before changed, when the modulation scheme was changed in conformity with a change in environment of a wireless section; collecting the log information generated in a wireless communication apparatus within a previously fixed first time period; fixing as a monitored apparatus the wireless communication apparatus that transmitted the log information, in a case where the number of changes in the modulation scheme exceeds a first threshold value; collecting information on a modulation scheme applied when wireless communication is performed for each second time period shorter than the first time period, and information on a data amount transmitted and received by applying the modulation scheme in the second time period, from the wireless communication apparatus specified as the monitored apparatus; and calculating a line use rate of a wireless line in the wireless section using the information collected for each the second time period.

A program according to a seventh aspect of the present invention makes a computer execute: collecting log information including information indicating change in a modulation scheme within a previously fixed first time period, from a wireless communication apparatus that changes the modulation scheme in conformity with a change in environment of a wireless section; fixing as a monitored apparatus the wireless communication apparatus that transmitted the log information, in a case where the number of changes in the modulation scheme exceeds a first threshold value in the first time period; collecting information on a modulation scheme applied when wireless communication is performed for each second time period shorter than the first time period, and information on a data amount transmitted and received by applying the modulation scheme in the second time period, from the wireless communication apparatus specified as the monitored apparatus; and calculating a line use rate of a wireless line in the wireless section using the information collected for each the second time period.

### Advantageous Effects of Invention

According to the present invention, there can be provided a monitoring apparatus, a wireless communication apparatus, a communication system, a line use rate calculation method, a data transmission method, a monitoring method, and a program that can efficiently collect traffic information of a wireless communication line in a communication system.

### BRIEF DESCRIPTION OF DRAWINGS

FIG. 1 is a configuration diagram of a monitoring apparatus according to an embodiment 1.

FIG. 2 is a configuration diagram of a communication system according to an embodiment 2.

FIG. 3 is a configuration diagram of an NE according to the embodiment 2.

FIG. 4 is a table showing log information according to the embodiment 2.

FIG. 5 is a configuration diagram of a monitoring apparatus according to the embodiment 2.

FIG. 6 shows graphs explaining a calculation method of a line use rate according to the embodiment 2.

FIG. 7 is a flow chart showing a flow of information collection processing between the monitoring apparatus and the NE according to the embodiment 2.

FIG. 8 is a flow chart showing a flow of information collection processing in the monitoring apparatus according to the embodiment 2.

FIG. 9 is a flow chart showing a flow of log information generation processing in the NE according to the embodiment 2.

FIG. 10 is a flow chart showing a flow of information collection processing between a monitoring apparatus and an NE according to an embodiment 3.

FIG. 11 is a flow chart showing a flow of information collection processing in the monitoring apparatus according to the embodiment 3.

### DESCRIPTION OF EMBODIMENTS

### Embodiment 1

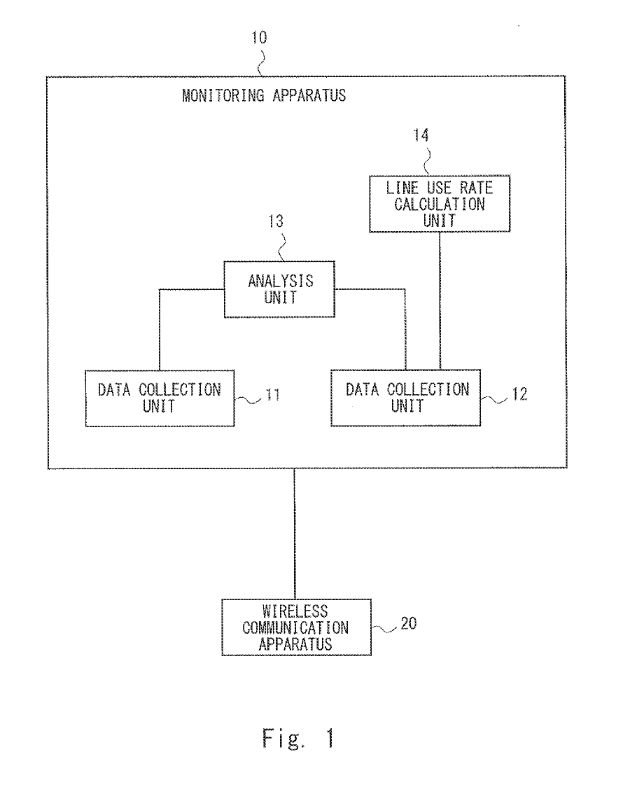

Hereinafter, embodiments of the present invention will be explained with reference to drawings. A monitoring apparatus 10 of FIG. 1 communicates with a wireless communication apparatus 20. The monitoring apparatus 10 may be a computer apparatus that operates by a CPU (Central Processing Unit) executing a program stored in a memory. The monitoring apparatus 10 has: a data collection unit 11; a data collection unit 12; an analysis unit 13; and a line use rate calculation unit 14.

The wireless communication apparatus 20 may be, for example, an apparatus that performs microwave communication with an opposed apparatus. In addition, a wired communication line may be used between the monitoring apparatus 10 and the wireless communication apparatus 20, or a wireless communication line may be used therebetween.

The data collection unit 11 collects log information including information indicating a change in a modulation scheme within a previously fixed time period T1, from the wireless communication apparatus 20 that changes the modulation scheme in conformity with a change in environment of a wireless section. In order to change the modulation scheme in conformity with the change in environment of the wireless section, an AMR (Adaptive Modulation Radio) function using multiple levels QAM may be used. The wireless section is, for example, a section between the wireless communication apparatus 20 and the other wireless communication apparatus that perform communication with each other through the wireless communication line. The wireless communication apparatus 20 may apply 32QAM as the modulation scheme, for example, in a case where communication quality of the wireless section is good, and may apply 16QAM decreased in multiple levels in a case where the communication quality of the wireless section is deteriorated. The communication quality of the wireless section may be determined using a previously fixed reference value of the communication quality. The communication quality may be, for example, fixed based on the number of discarded packets, a data rate, etc.

The previously fixed time period T1 may be, for example, fixed as a fifteen-minute period or the like. The log information is information regularly generated by the wireless communication apparatus 20. The log information may be statistical information generated using information accumulated in the memory. The information indicating the change in the modulation scheme, the information being included in the log information, may be information on the number of changes in the modulation scheme or a timing at which the modulation scheme was changed.

The analysis unit 13 fixes as a monitored apparatus the wireless communication apparatus 20 that transmitted the log information, in a case where the number of changes in the modulation scheme exceeds a threshold value. The monitored apparatus transmits information to the monitoring apparatus 10 more frequently compared with an unmonitored apparatus. The analysis unit 13 specifies the number of changes in the modulation scheme from the information indicating the change in the modulation scheme, the information being included in the log information. The analysis unit 13 determines whether or not the specified number of times exceeds the threshold value by comparing the specified number of times with the previously fixed threshold value.

The data collection unit 12 collects information on a modulation scheme applied when wireless communication is performed for each time period T2 shorter than the time period T1, and information on a transmitted and received data amount, from the wireless communication apparatus 20 specified as the monitored apparatus in the analysis unit 13. For example, in a case where the time period T1 is set to be fifteen minutes, the time period T2 may be set to be one minute or the like. The information collected by the data collection unit 12 may be the log information generated by the wireless communication apparatus 20, or may be the information accumulated in the memory, the information being used by the wireless communication apparatus 20 in order to generate the log information. In addition, although the data collection unit 11 and the data collection unit 12 are shown as different functional blocks in FIG. 1, they may be realized by the same functional block or hardware.

The line use rate calculation unit 14 calculates a line use rate of the wireless communication line in the wireless section managed by the wireless communication apparatus 20, using the information collected in the data collection unit 12. For example, the line use rate calculation unit 14 calculates a line use rate in the time period T2 using a line capacity fixed by the applied modulation scheme, and the transmitted and received data amount.

As explained above, the monitored apparatus can be fixed using the information on the number of changes in the modulation scheme by using the monitoring apparatus 10 of FIG. 1. Generally, in a case where communication quality is stable, it is considered that there is small number of changes in the modulation scheme. In other words, in a case where the number of changes in the modulation scheme exceeds the threshold value, it can be regarded that the communication quality is unstable. Therefore, the monitoring apparatus 10 can fix as a monitored apparatus a wireless communication apparatus that manages a wireless section in which communication quality is unstable.

Further, the monitoring apparatus 10 can collect data from the monitored apparatus for each time period T2 shorter than the time period T1. That is, the monitoring apparatus 10 limits wireless communication apparatuses to which the time period T2 is applied, and thereby a data amount transmitted and received in the entire communication system can be decreased compared with a case where the time period T2 is applied to all the wireless communication apparatuses. Hereby, congestion can be prevented from occurring in the communication system.

### Embodiment 2

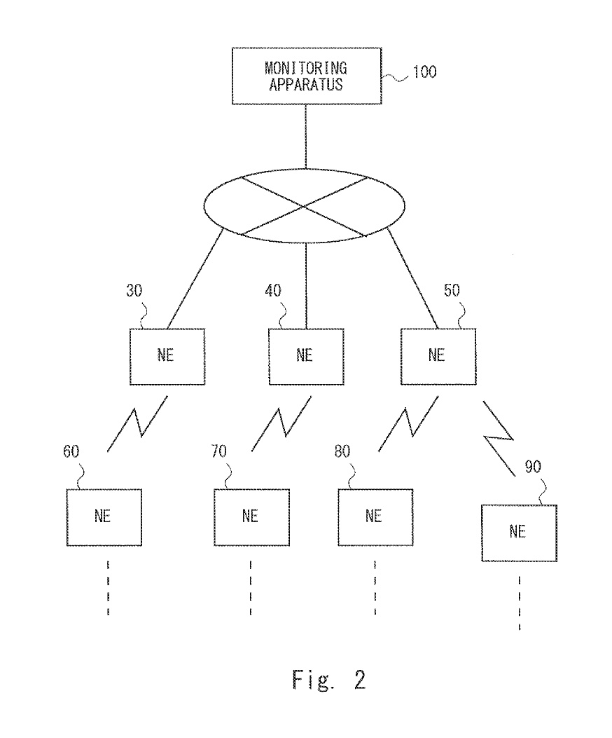

Subsequently, using FIG. 2, there will be explained a configuration example of a communication system according to an embodiment 2 of the present invention. The communication system of FIG. 2 has the monitoring apparatus 100 and NEs (Network Elements) 30 to 90. The NE corresponds to the wireless communication apparatus 20 of FIG. 1. The NE 30 wirelessly communicates with the NE 60. The NE 40 wirelessly communicates with the NE 70. The NE 50 wirelessly communicates with the NEs 80 and 90. In addition, the NEs 60 to 90 may wirelessly communicate with other NEs that are not shown.

The monitoring apparatus 100 communicates with the NEs 30 to 50 through a communication network. For example, the monitoring apparatus 100 collects from the NE 30 information such as a traffic amount between the NE 30 and the NE 60. Further, the monitoring apparatus 100 collects from the NE 60 information such as a traffic amount between the NE 60 and the other NE. At this time, the monitoring apparatus 100 collects from the NE 60 the information such as the traffic amount through a wireless communication line between the NE 30 and the NE 60, and the communication network.

That is, in a case where the monitoring apparatus 100 collects information on all wireless sections for each time period T2, congestion may occur not only in the communication network between the NEs 30 to 50 and the monitoring apparatus 100 but in the wireless sections between the NEs. Therefore, the monitoring apparatus 100 limits the NEs from which information is collected, and thereby congestion can be avoided from occurring, or points where the congestion occurs can be decreased.

Subsequently, using FIG. 3, there will be explained a configuration example of the NE 30 according to the embodiment 2 of the present invention. The NE 30 has an MIB (Management Information Base) information generation unit 31 and a log information generation unit 32.

The MIB information generation unit 31 generates MIB information. The MIB information includes the traffic amount transmitted and received between the NE 30 and the NE 60, a modulation scheme applied to wireless communication, timing at which the traffic amount was measured, a data loss amount, etc. In addition, as described above, MIB information on a communication situation may be referred to as RMON (Remote network Monitoring) MIB information. The MIB information generation unit 31 may store the generated MIB information in a memory of the NE 30, etc. The MIB information may be referred to as memory information.

The log information generation unit 32 generates log information that is statistical information using plural pieces of MIB information. For example, the log information generation unit 32 may generate the log information using plural pieces of MIB information collected for a predetermined time period.

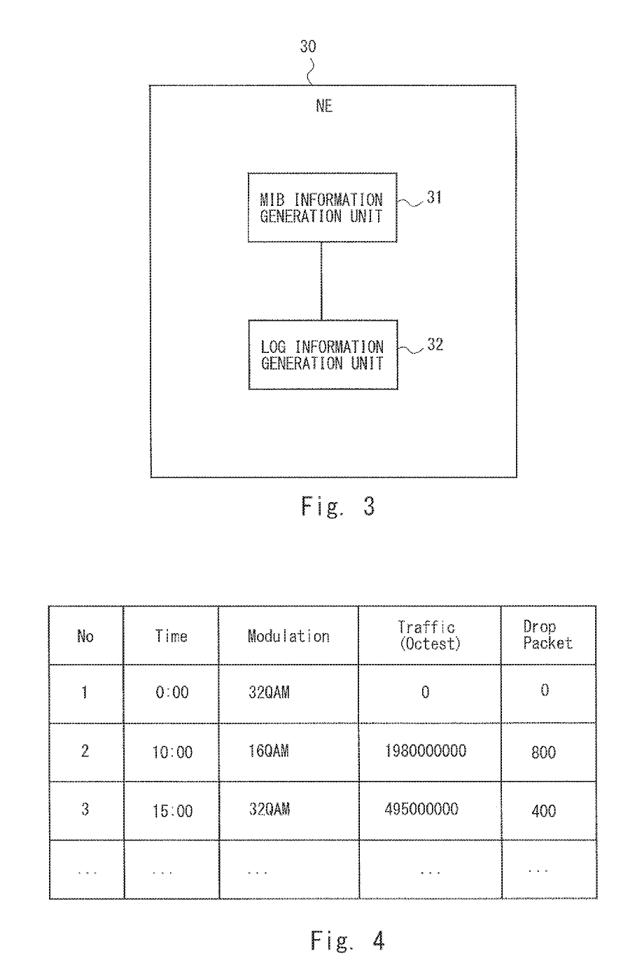

Here, log information generated by the log information generation unit 32 will be explained using FIG. 4. The log information of FIG. 4 indicates that wireless communication to which 32QAM has been first applied as the modulation scheme is started. Further, it indicates that the modulation scheme is changed to 16QAM after elapse of ten minutes from the communication start. Further, it indicates that in ten minutes after the communication start, the modulation scheme of 32QAM is applied, and that traffic of 1980M Octet is generated. In addition, it indicates that 800 packets are lost in ten minutes after the communication start.

Further, the log information of FIG. 4 indicates that the modulation scheme is changed to 32QAM after elapse of fifteen minutes from the communication start, in five minutes from the elapse of ten minutes to the elapse of fifteen minutes, the modulation scheme of 16QAM is applied, and that traffic of 495M Octet is generated. In addition, it indicates that 400 packets are lost in five minutes from the elapse of ten minutes to the elapse of fifteen minutes.

As shown in FIG. 4, the log information is generated so that timing at which the modulation scheme was changed, and a traffic amount and a packet loss amount generated before the modulation scheme was changed can be grasped.

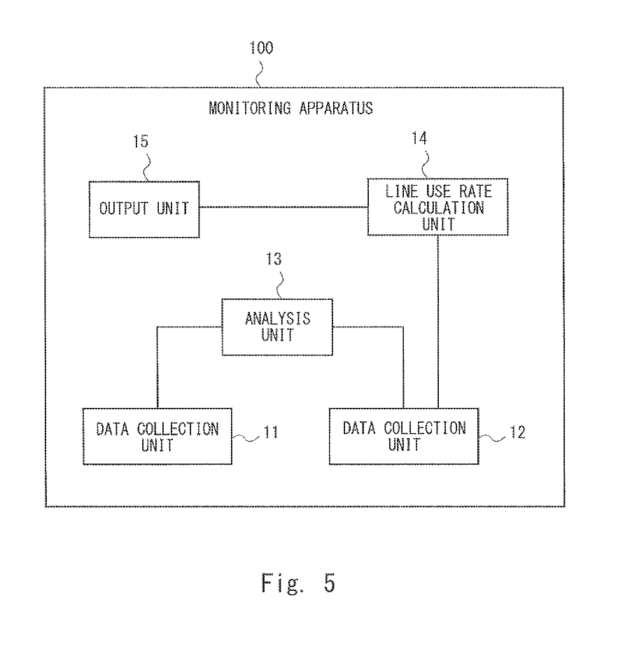

Subsequently, using FIG. 5, there will be explained a detailed configuration example of the monitoring apparatus 100 according to the embodiment 2 of the present invention. The monitoring apparatus 100 has a configuration in which an output unit 15 is added to the monitoring apparatus 10 of FIG. 1. In FIG. 5, points different from FIG. 1 will be mainly explained.

The data collection unit 11 collects log information regularly generated in the log information generation unit 32. In addition, the data collection unit 11 collects log information from all the NEs arranged in a monitored area. For example, the data collection unit 11 collects log information from the NEs 30 to 90 of FIG. 4. For example, the data collection unit 11 may use a FTP (File Transfer Protocol) in collecting the log information.

The data collection unit 12 collects MIB information generated in the MIB information generation unit 31 of a monitored NE. The monitored NE is an NE decided in the analysis unit 13 from the plurality of NEs arranged in the monitored area. For example, in a case where the NE 30 is decided as the monitored NE in the analysis unit 13, the data collection unit 12 collects MIB information from the NE 30 among the NEs 30 to 90. The data collection unit 12 collects the MIB information from the monitored NE in a period shorter than a period in which the data collection unit 11 collects the log information.

The data collection unit 12 may operate as an SNMP (Simple Network Management Protocol) manager in order to collect the MIB information from the monitored NE. In addition, the MIB information generation unit 31 that transmits the MIB information to the data collection unit 12 may operate as an SNMP agent.

The analysis unit 13 decides an NE to be monitored using the collected log information. For example, assume that the analysis unit 13 has received the log information shown in FIG. 4 from the NE 30. The log information shown in FIG. 4 indicates that the number of changes in the modulation scheme is twice. For example, in a case where a threshold value is fixed as once, the analysis unit 13 determines that communication quality of the wireless section managed by the NE 30 is unstable, since the number of changes in the modulation scheme indicated in the received log information is twice. In this case, the analysis unit 13 sets the NE 30 as a monitoring target. That is, in a case where the number of changes in the modulation scheme exceeds the threshold value, the analysis unit 13 sets the NE having transmitted the log information as the monitoring target.

Alternatively, the analysis unit 13 may decide the NE set as the monitoring target using the number of times the modulation scheme was changed in order to decrease modulation multiple levels among the number of changes in the modulation scheme. For example, in the log information of FIG. 4, the modulation scheme is changed once from 32QAM to 16QAM, and is changed once from 16QAM to 32QAM.

In the case where the modulation scheme is changed from 32QAM to 16QAM, the analysis unit 13 determines that the modulation scheme is changed in order to decrease the modulation multiple levels. In this case, the analysis unit 13 compares the number of times the modulation scheme was changed in order to decrease the modulation multiple levels, i.e. once, with the number of times fixed as the threshold value, and determines whether or not the communication quality of the wireless section managed by the NE 30 is unstable. The AMR function generally changes the modulation scheme so as to decrease the modulation multiple levels, in a case where the communication quality is lowered. Therefore, it can be estimated whether or not the communication quality of the wireless section managed by the NE is deteriorated, by using only the number of times the modulation scheme was changed so that the multiple levels may be decreased, among the number of changes in the modulation scheme.

The output unit 15 may be, for example, an LCD (Liquid Crystal Display) or the like. The output unit 15 displays the line use rate calculated in the line use rate calculation unit 14. In addition, the output unit 15 may transmit to the other apparatus information on the line use rate calculated in the line use rate calculation unit 14. The monitoring apparatus 100 may make a display unit of the other apparatus display the line use rate calculated in the monitoring apparatus 100 by transmitting the information on the line use rate to the other apparatus. The monitoring apparatus 100 may transmit the line use rate to the other apparatus through a wireless communication line or a wired communication line.

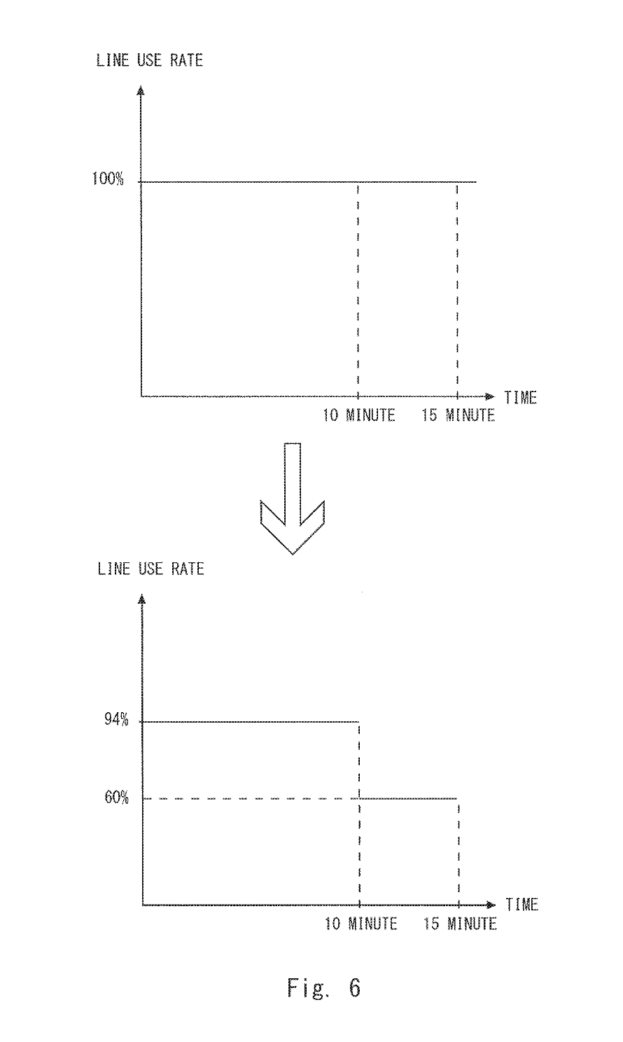

Subsequently, a calculation method of the line use rate in the line use rate calculation unit 14 will be explained using FIG. 6. Note that in FIG. 6, a generally used calculation method of a line use rate will also be explained as a comparative example. An upper graph of FIG. 6 shows results of having applied the generally used calculation method of the line use rate, and a lower graph of FIG. 6 shows results of the line use rates calculated using the line use rate calculation unit 14 of FIG. 5.

A general line use rate is, for example, calculated using regularly collected log information. For example, a case will be explained where log information is collected for each fifteen minutes. Assume that traffic of 2475M Octet has occurred in fifteen minutes. In addition, information on the applied modulation scheme is not shown in general log information. Therefore, the line use rate is calculated assuming that a particular modulation scheme is used without consideration for the AMR function. In the upper graph of FIG. 6, a case will be explained where 16QAM is applied as the modulation scheme.

In a case of applying the generally used calculation method of the line use rate, a line speed (Mbps) is calculated by the following formula: 2475M×8/60 s/15 m=22 Mbps. In addition, in a case where a line capacity when 16QAM is applied as the modulation scheme is set to be 22 Mbps, the line use rate is calculated by the following formula: 22 Mbps/22 Mbps=100%. That is, the upper graph of FIG. 6 shows that the line use rate is 100% until elapse of fifteen minutes from measurement start.

Meanwhile, in a case of using the line use rate calculation unit 14 of FIG. 5, the line use rate can be calculated in consideration of change in the modulation scheme. Specifically, there will be explained a case of using the log information shown in FIG. 4. FIG. 4 shows that the modulation scheme is changed from 32QAM to 16QAM after elapse of ten minutes from measurement start. In addition, it shows that traffic of 1980M Octet has occurred in ten minutes after the measurement start. Hereby, a line speed for ten minutes after the measurement start is calculated by the following formula: 1980M×8/60 s/15 m=26.4 Mbps. In addition, in a case where a line capacity when 32QAM is applied as the modulation scheme is set to be 28 Mbps, the line use rate is calculated by the following formula: 22 Mbps/28 Mbps=approximately 94%.

Further, FIG. 4 shows that traffic of 495M Octet has occurred in five minutes from elapse of ten minutes to elapse of fifteen minutes. Hereby, a line speed for this five minutes is calculated by the following formula: 495M×8/60 s/5 m=13.2 Mbps. In addition, in a case where the line capacity when 16QAM is applied as the modulation scheme is set to be 22 Mbps, the line use rate is calculated by the following formula: 13.2 Mbps/22 Mbps=60%.

As described above, timing at which the modulation scheme was changed is specified, the line use rate is calculated in consideration of the line capacity according to the applied modulation scheme, and thereby an accurate line use rate can be calculated. For example, in a case of using the general calculation method of the line use rate in an example of FIG. 6, the line use rate is calculated to be 100% for fifteen minutes after measurement start. In this case, an administrator of a communication network, etc. needs to increase the line capacity, etc. In addition, an amount of capital investment to the communication network also increases along with the increase in line capacity.

In contrast with this, in the case of using the line use rate calculation unit 14 of FIG. 5, it turns out that the line use rate for fifteen minutes after the measurement start actually has not reached 100%. Therefore, the administrator of the communication network, etc. can determine that there is no need to immediately increase the line capacity.

In addition, a modulation scheme with more multiple levels than 16QAM may be used in some cases in the general calculation method of the line use rate of FIG. 6. In such a case, the line use rate becomes lower than the case of using 16QAM as the modulation scheme. However, the line use rate using the line use rate calculation unit 14 of FIG. 5, which indicates a value near an actual line use rate, may become higher in some cases than the line use rate calculated in accordance with the general calculation method of the line use rate. The administrator of the communication network, etc. will refer to a line use rate lower than the actual line use rate, in deciding a time to increase the line capacity, etc. in accordance with the general calculation method of the line use rate. In this case, it is also considered that the administrator of the communication network, etc. make mistakes in deciding the time to increase the line capacity.

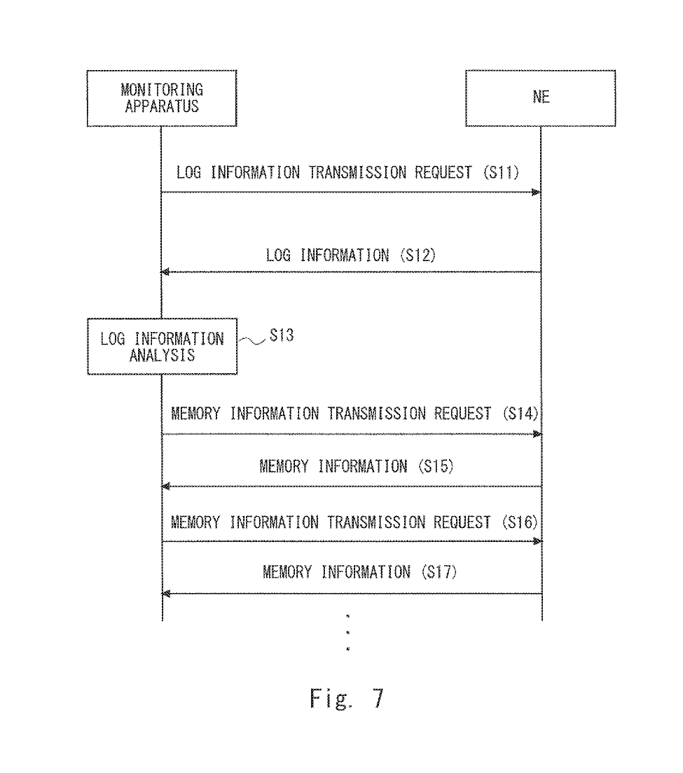

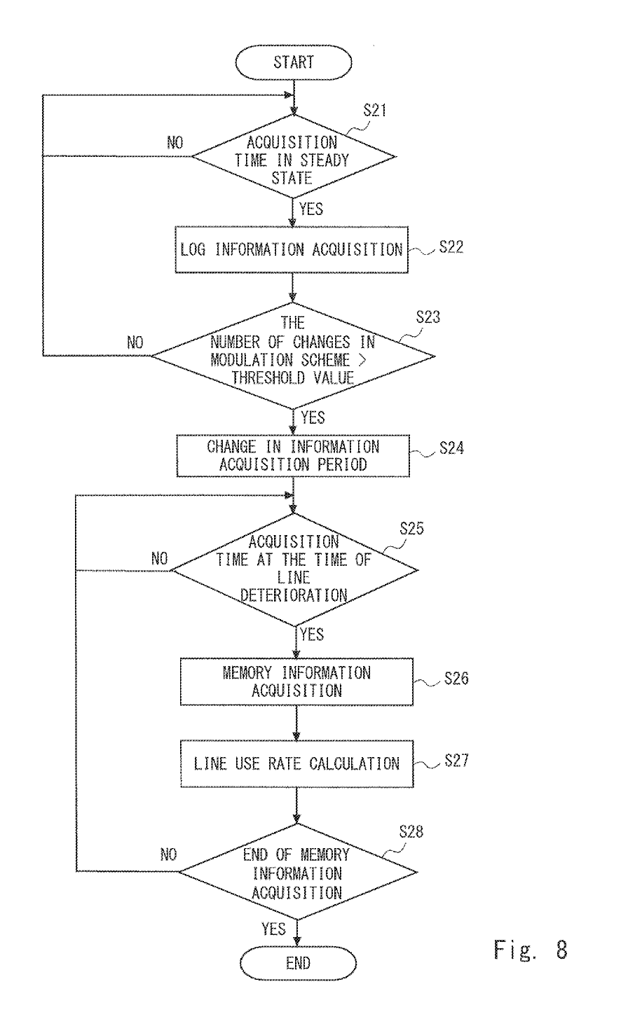

Subsequently, using FIG. 7, there will be explained a flow of information collection processing between the monitoring apparatus 100 and the NE 30 according to the embodiment 2 of the present invention. First, the monitoring apparatus 100 transmits a log information transmission request message to the NE 30 (S11). Next, the NE 30 transmits to the monitoring apparatus 100 log information generated in the log information generation unit 32 as a response of the log information transmission request message (S12). Next, the analysis unit 13 of the monitoring apparatus 100 analyzes the received log information (S13). Specifically, the analysis unit 13 determines whether or not the number of changes in the modulation scheme in the NE 30 exceeds a previously fixed threshold value. Here, assume that the analysis unit 13 has determined that the number of changes in the modulation scheme in the NE 30 exceeds the previously fixed threshold value.

Next, the monitoring apparatus 100 transmits a memory information transmission request message to the NE 30 (S14). Memory information may be information stored in the memory of the NE 30 and, for example, may be MIB information. Next, the NE 30 transmits to the monitoring apparatus 100 the memory information generated in the MIB information generation unit 31 as a response of the memory information transmission request message (S15). Next, the monitoring apparatus 100 and the NE 30 repeats processing similar to that of steps S14 and S15, in steps S16 and S17. In addition, the monitoring apparatus 100 collects the memory information in a period shorter than a period to collect the log information.

In addition, a frequency at which the monitoring apparatus 100 collects the memory information may be fixed according to the number of changes in the modulation scheme in the log information analyzed in the analysis unit 13. For example, the monitoring apparatus 100 estimates that the larger the number of changes in the modulation scheme in the log information is, the more the communication quality in the wireless section is deteriorated, and it may increase the frequency of collecting the memory information. In addition, the less the number of changes in the modulation scheme in the log information is, the more the monitoring apparatus 100 may reduce the frequency of collecting the memory information.

Subsequently, using FIG. 8, there will be explained a flow of information collection processing in the monitoring apparatus 100 according to the embodiment 2 of the present invention. First, the data collection unit 11 determines whether or not it is an acquisition time in a steady state where log information is collected (S21). The acquisition time in the steady state is set based on the previously fixed time period T1. If the data collection unit 11 determines that it is not the acquisition time in the steady state, it repeats processing of step S21.

If the data collection unit 11 determines that it is the acquisition time in the steady state, it collects the log information from the NE 30 (S22). Specifically, the data collection unit 11 transmits a log information transmission request message to the NE 30, and receives the log information as a response of the message.

Next, the analysis unit 13 specifies the number of changes in the modulation scheme from the log information, and determines whether or not the number of changes in the modulation scheme exceeds a threshold value (S23). If the analysis unit 13 determines that the number of changes in the modulation scheme does not exceed the threshold value, it repeats the processing of step S21. If the analysis unit 13 determines that the number of changes in the modulation scheme exceeds the threshold value, it changes a period to acquire information from the NE 30 (S24). In addition, the analysis unit 13 changes the period to acquire the information, and also changes information to be acquired. Specifically, although the analysis unit 13 collects the log information from the NE 30 in a period of the time period T1, it decides to collect memory information from the NE 30 in a period of the time period T2. Time information set based on the period of the time period T2 indicates an acquisition time at the time of line deterioration. The line deterioration means that communication quality in the wireless section is deteriorated.

Next, the data collection unit 12 determines whether or not now is the acquisition time at the time of line deterioration (S25). If the data collection unit 12 determines that now is not the acquisition time at the time of line deterioration, it repeats processing of step S25. If the data collection unit 12 determines that now is the acquisition time at the time of line deterioration, it acquires the memory information from the NE 30 (S26). Specifically, the data collection unit 12 transmits a memory information transmission request message to the NE 30, and receives the memory information as a response of the message.

Next, the line use rate calculation unit 14 calculates a line use rate of a line managed by the NE 30 using the acquired memory information (S27). Next, the data collection unit 12 determines whether to end processing to acquire the memory information (S28). Acquisition processing of the memory information may be ended, for example, in a case where information indicating processing end from a user is input, or in a case where the previously fixed number of times of processing to acquire the memory information is carried out.

If the data collection unit 12 determines that the processing to acquire the memory information is not ended, it repeats the processing of step S25. If the data collection unit 12 determines that the processing to acquire the memory information is ended, it ends the processing.

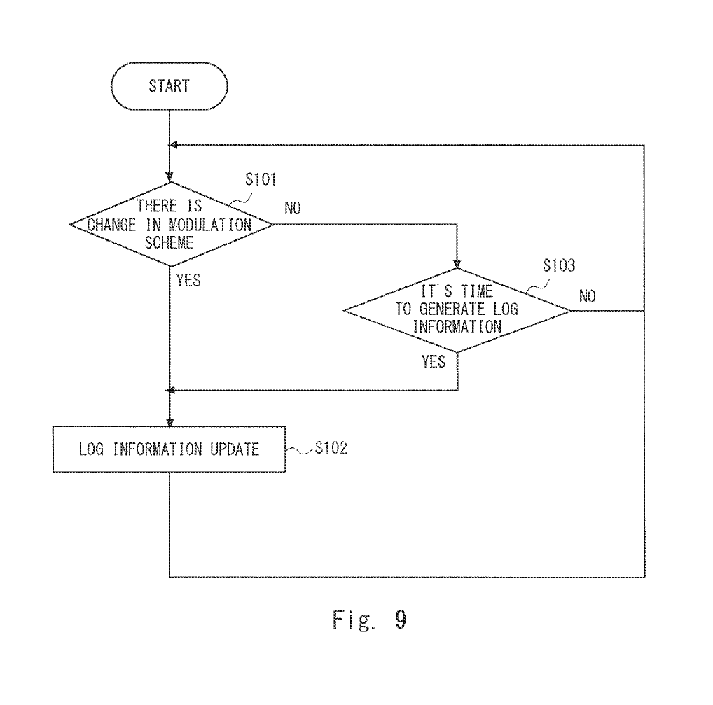

Subsequently, using FIG. 9, there will be explained a flow of log information generation processing in the NEs according to the embodiment 2 of the present invention. First, the log information generation unit 32 determines whether or not the modulation scheme was changed in the MIB information generated in the MIB information generation unit 31 (S101). Next, if the log information generation unit 32 determines that the modulation scheme was changed, it updates or generates the log information (S102). The log information generation unit 32 repeats processing of step S101 or later, after updating the log information.

In step S101, if the log information generation unit 32 determines that the modulation scheme was not changed, it determines whether or not it is a time or timing to generate the log information (S103). If the log information generation unit 32 determines that it is the time to generate the log information, it updates or generates the log information (S102). If the log information generation unit 32 determines that it is not the time to generate the log information, it repeats the processing of step S101 or later.

As explained above, the monitoring apparatus 100 can grasp the number of changes in the modulation scheme between the NEs that communicate with each other through the wireless communication line, by using the communication system according to the embodiment 2 of the present invention. Hereby, the monitoring apparatus 100 can estimate whether or not communication quality between the NEs is deteriorated. In addition, the monitoring apparatus 100 can specify the NE that manages the wireless section in which communication quality is deteriorated. Further, the monitoring apparatus 100 can acquire information on a generated traffic amount and an applied modulation scheme only from the specified NE in a short period. As described above, a load of the entire communication system can be prevented from increasing by limiting the NE from which the information is acquired in the short period.

### Embodiment 3

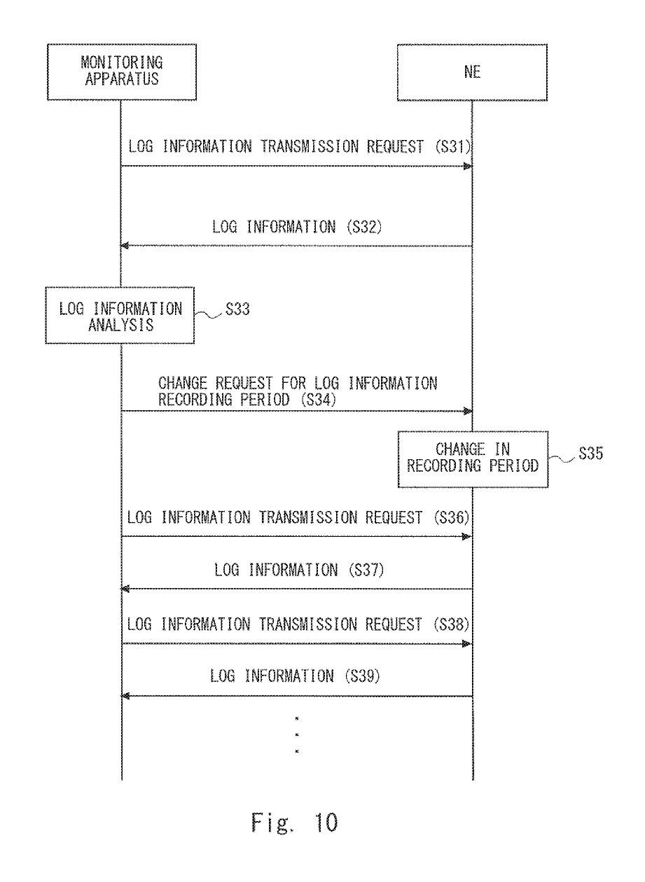

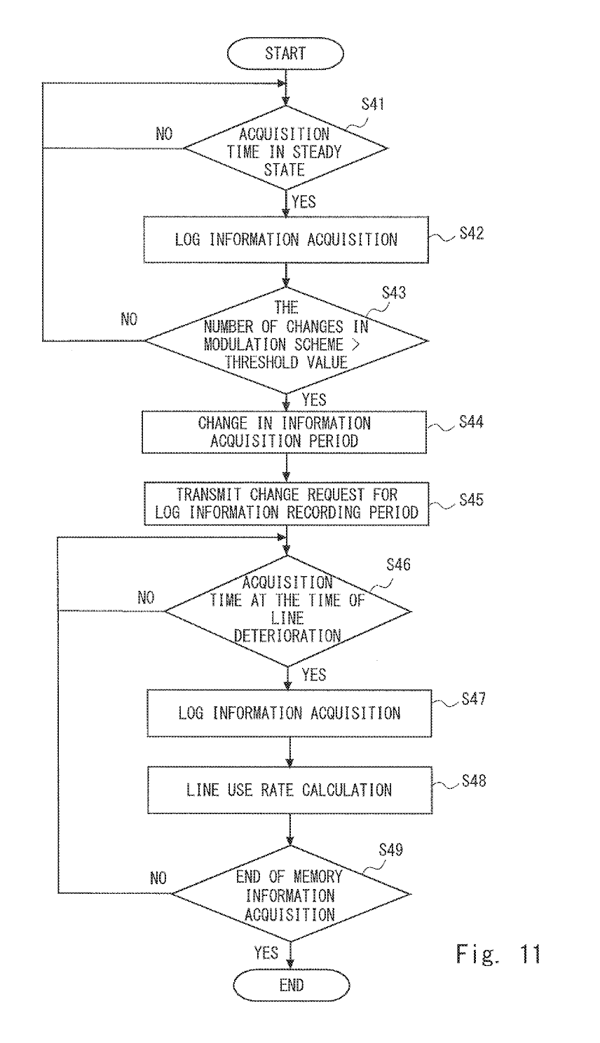

Subsequently, using FIG. 10, there will be explained a flow of information collection processing between the monitoring apparatus 100 and the NE 30 according to an embodiment 3 of the present invention. Since steps S31 to S33 are similar to steps S11 to S13 of FIG. 7, detailed explanation thereof is omitted.

Assume that in step S33, the analysis unit 13 of the monitoring apparatus 100 has determined that the number of changes in the modulation scheme in the NE 30 exceeds a previously fixed threshold value. In this case, the data collection unit 11 transmits a change request message of a log information recording period (S34). In the change request message of the log information recording period, there is set a content to instruct the log information generation unit 32 of the NE 30 to make a period to generate log information using MIB information shorter than a current period. That is, the monitoring apparatus 100 collects the log information generated by the log information generation unit 32 as information acquired in a short period from the NE 30 in which communication quality is deteriorated.

Next, the NE 30 changes the recording period of the log information in accordance with the change request message of the log information recording period (S35). In other words, the NE 30 changes it so that a time between log information generation times may become shorter.

Next, the monitoring apparatus 100 transmits a log information transmission request message to the NE 30 (S36). Next, the NE 30 transmits log information as a response of the log information transmission request message (S37). The log information transmitted by the NE 30 is information generated in a period changed in accordance with the change request message of the log information recording period. Also in steps S38 and S39, processing of steps S36 and S37 is repeated. In addition, the monitoring apparatus 100 makes an interval to transmit the log information transmission request message of step S36 or later shorter than an interval to transmit the log information transmission request message in step S31

Subsequently, using FIG. 11, there will be explained a flow of information collection processing in the monitoring apparatus 100 according to the embodiment 3 of the present invention. Since steps S41 to S44 are similar to steps S21 to S24 of FIG. 8, detailed explanation thereof is omitted. In step S44, the analysis unit 13 changes a time period to collect log information from the NE 30 from the time period T1 to the time period T2. However, in processing in step S44, information to be acquired is not changed to memory information unlike step S24 of FIG. 8. That is, the analysis unit 13 collects the log information, even after the period to acquire the information is changed.

Next, the analysis unit 13 transmits a change request message of a log information recording period to the NE 30 through the data collection unit 11 (S45). Since steps S46, S48, and S49 are similar to steps S25, S27, and S28 of FIG. 8, detailed information thereof is omitted. Step S47 is different from step S26 of FIG. 8 in that the monitoring apparatus 100 acquires the log information.

As explained above, by using the communication system according to the embodiment 3 of the present invention, the monitoring apparatus 100 can acquire the log information from the NE that manages the wireless section in which the communication quality is deteriorated, after the period to acquire the information is shortened. Hereby, the monitoring apparatus 100 need not be equipped with a function to collect the MIB information from the NE 30, and can be equipped with only a function to collect the log information. Hereby, a processing load in the monitoring apparatus 100 can be reduced.

Although the present invention has been explained as a configuration of hardware in the above-mentioned embodiments, the present invention is not limited to this. In the present invention, the processing in FIGS. 8, 9, and 11 can also be realized by making a CPU (Central Processing Unit) execute a computer program.

In the above-mentioned examples, the program is stored using various types of non-transitory computer-readable media, and can be supplied to a computer. The non-transitory computer-readable media include various types of tangible storage media. Examples of the non-transitory computer-readable media include: a magnetic recording medium (for example, a flexible disk, a magnetic tape, a hard disk drive); a magnetic optical recording medium (for example, a magnetic optical disk); a CD-ROM (Read Only Memory); a CD-R; a CD-R/W; and a semiconductor memory (for example, a mask ROM, a PROM (Programmable ROM), an EPROM (Erasable PROM), a flash ROM, an RAM (Random Access Memory)). In addition, the program may be supplied to the computer by various types of transitory computer-readable media. Examples of the transitory computer-readable media include an electrical signal, an optical signal, and an electromagnetic wave. The transitory computer-readable medium can supply the program to the computer through a wired communication path, such as an electric wire and an optical fiber, or a wireless communication path.

Note that the present invention is not limited to the above-described embodiments, and that they can be appropriately changed without departing from the scope of the invention.

Hereinbefore, although the invention in the present application has been explained with reference to the embodiments, it is not limited by the above. Various changes that can be understood by those skilled in the art can be made to the configurations and the details of the invention in the present application within the scope of the invention.

This application claims priority based on Japanese Patent Application No. 2015-000181 filed on Jan. 5, 2015, and the entire disclosure thereof is incorporated herein.

### REFERENCE SIGNS LIST

10 monitoring apparatus
11 data collection unit
12 data collection unit
13 analysis unit
14 line use rate calculation unit
15 output unit
20 wireless communication apparatus
30 NE
30 to 90 NE
31 MIB information generation unit
32 log information generation unit
100 monitoring apparatus

1. A monitoring apparatus comprising:
at least one memory storing instructions, and
at least one processor configured to execute the instructions to;
collect log information including information indicating change in a modulation scheme within a previously fixed first time period, from a wireless communication apparatus that changes the modulation scheme in conformity with a change in environment of a wireless section;
fix as a monitored apparatus the wireless communication apparatus that transmitted the log information, in a case where the number of changes in the modulation scheme exceeds a first threshold value in the first time period;
collect information on a modulation scheme applied when wireless communication is performed for each second time period shorter than the first time period, and information on a data amount transmitted and received by applying the modulation scheme in the second time period, from the wireless communication apparatus specified as the monitored apparatus; and
calculate a line use rate of a wireless line in the wireless section using the collected information.

2. The monitoring apparatus according to claim 1, wherein the at least one processor of the monitoring apparatus is further configured to execute the instructions to fix as the monitored apparatus the wireless communication apparatus that transmitted the log information, in a case where the number of times the modulation scheme was changed so that multiple levels may be decreased, among the number of changes in the modulation scheme, exceeds a second threshold value.

3. The monitoring apparatus according to claim 1, wherein the at least one processor of the monitoring apparatus is further configured to execute the instructions to output information on the calculated line use rate calculated.

4. The monitoring apparatus according to claim 1, wherein the at least one processor of the monitoring apparatus is further configured to execute the instructions to collect information on a modulation scheme applied when wireless communication is performed for each the second time period, and information on a data amount transmitted and received by applying the modulation scheme in the second time period, as MIB information held in the wireless communication apparatus or the log information generated using the MIB information.

5. A wireless communication apparatus comprising:
at least one memory storing instructions, and
at least one processor configured to execute the instructions to;
generate log information that indicates information indicating change in a modulation scheme and information on a data amount transmitted and received by applying the modulation scheme, when the modulation scheme was changed in conformity with a change in environment of a wireless section; and
transmit to a monitoring apparatus the log information generated within a previously fixed first time period.

6. (canceled)

7. (canceled)

8. A line use rate calculation method comprising:
collecting log information including information indicating change in a modulation scheme within a previously fixed first time period, from a wireless communication apparatus that changes the modulation scheme in conformity with a change in environment of a wireless section;
fixing as a monitored apparatus the wireless communication apparatus that transmitted the log information, in a case where the number of changes in the modulation scheme exceeds a first threshold value in the first time period;
collecting information on a modulation scheme applied when wireless communication is performed for each second time period shorter than the first time period, and information on a data amount transmitted and received by applying the modulation scheme in the second time period, from the wireless communication apparatus specified as the monitored apparatus; and
calculating a line use rate of a wireless line in the wireless section using the information collected for each the second time period.

9. (canceled)

10. (canceled)

11. (canceled)
